(19) United States
(12) Patent Application Publication
(10) Pub. No.: US 2025/0185685 A1
(43) Pub. Date: Jun. 12, 2025

(54) COFFEE BEVERAGE

(71) Applicant: SOCIETE DES PRODUITS NESTLE S.A., Vevey (CH)

(72) Inventors: VALERIE MARTINE JEANINE LELOUP, Orbe (CH); OLIVIER BERRUT, Pully (CH); MURIEL HENRION, Orbe (CH); ELOI BURGOS, Pully (CH); XING FAN, Bussigny (CH); SIDHANTH TYAGI, Lausanne (CH); LAURENT FORNY, Lausanne 26 (CH)

(21) Appl. No.: 18/856,480

(22) PCT Filed: Apr. 13, 2023
(86) PCT No.: PCT/EP2023/059700

§ 371 Date: Oct. 11, 2024

(30) Foreign Application Priority Data
Apr. 14, 2022 (EP) 22168305.5
Jul. 19, 2022 (CN) 202210849909.9

(51) Int. Cl. A23F 5/36; A23F 5/26; A23F 5/28

(52) U.S. Cl. CPC A23F 5/36; A23F 5/26; A23F 5/28

(57) ABSTRACT

The present invention relates to a coffee beverage and a method of manufacturing a coffee beverage.

### FIELD OF THE INVENTION

The present invention relates to a coffee beverage composition and a method of manufacturing a coffee beverage composition.

### BACKGROUND OF THE INVENTION

The consumption of cold coffee is increasingly popular. Chilled coffee competes with other non-alcoholic beverages to provide consumers with refreshment, the consumers appreciating coffee's natural origins and the low inherent level of sugar. Existing instant coffee powders provide a convenient way to prepare hot coffee, but often have poor dissolution and result in a cloudy cup of coffee when prepared with cold water. The perception of a food or drink as being refreshing is often associated with specific sensory characteristics related to psychophysiological states linked with water drinking. Clear beverages are generally rated as most refreshing because of the association between clarity and water. It would therefore be desirable to provide a convenient means to prepare coffee in cold water with good clarity. Ideally this should be combined with easy dissolution and great taste in cold water or cold milk.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide a solution to overcome at least some of the inconveniences described above or at least to provide a useful alternative. The object of the present invention is achieved by the subject matter of the independent claims. The dependent claims further develop the idea of the present invention.

Accordingly, the present invention provides in a first aspect a coffee beverage composition comprising coffee extract wherein at least 8 wt. % of the coffee extract solids present are mannans and less than 4.2 wt. % of the coffee extract solids are mannans having a molecular mass greater than 5000 Da.

In a second aspect, the invention provides a container for use in a beverage preparation device, the container containing the coffee beverage composition of the invention.

A third aspect of the invention is a method of manufacturing a coffee beverage composition, the method comprising;
a. extracting soluble coffee solids from ground roasted coffee in a first extraction stage using an aqueous extraction fluid at a temperature of 80° C. to 150° C. for 1 to 60 minutes to provide a primary coffee extract and primary extracted coffee grounds,
b. extracting soluble coffee solids from the primary extracted grounds in a second extraction stage using an aqueous extraction fluid at a temperature of 151° C. to 190° C. for 1 to 80 minutes to provide a secondary coffee extract and secondary extracted coffee grounds,
c. optionally subjecting the secondary extracted coffee grounds to a heat treatment in the presence of water from 191° C. to 260° C. for 1 to 15 minutes and either separating the liquid portion as tertiary coffee extract or performing an aqueous extraction of the heat treated secondary extracted coffee grounds to provide a tertiary coffee extract.
d. treating at least part of the secondary coffee extract at a temperature of 170° C. to 220° C. for 1 to 60 minutes to provide hydrolysed secondary coffee extract,
e. optionally treating at least part of the tertiary coffee extracts at a temperature of 170° C. to 220° C. for 1 to 60 minutes to provide hydrolysed tertiary coffee extract,
f. forming a combined coffee extract comprising on a solids basis 20-60 wt. % primary coffee extract, 0-25 wt. % secondary coffee extract, 20-70 wt. % hydrolysed secondary coffee extract, 0-30 wt. % tertiary extract and 0-30 wt. % hydrolysed tertiary coffee extract.

It has been surprisingly found by the inventors that by controlling the size distribution of mannans it is possible to obtain a coffee beverage composition that dissolves well in cold water to form a clear beverage with low turbidity. This can be achieved whilst still providing a coffee beverage with an attractive taste profile.

5 High yield industrial coffee extracts such as extracts where at least 8 wt. % of the coffee extract solids present are mannans are usually turbid. Surprisingly, the inventors have found that it is possible to obtain a coffee beverage composition with low turbidity from a high yield coffee extract by ensuring that less than 4.2 wt. % of the coffee extract solids are mannans having a molecular mass greater than 5000 Da. In addition, the inventors have surprisingly found that a soluble coffee powder prepared from a high yield coffee extract dissolves rapidly if the mannan composition is controlled such that less than 4.2 wt. % of the coffee extract solids are mannans having a molecular mass greater than 5000 Da.

### BRIEF DESCRIPTION OF THE DRAWINGS

FIG. 1 shows the size distribution of total carbohydrates (dark line) and mannans (light line) for Sample A. The x-axis is molecular mass in Da and the y-axis has units of g/100 g product.

FIG. 2 shows the size distribution of total carbohydrates (dark line) and mannans (light line) for Sample B. The x-axis is molecular mass in Da and the y-axis has units of g/100 g product.

FIG. 3 shows the size distribution of total carbohydrates (dark line) and mannans (light line) for Sample C. The x-axis is molecular mass in Da and the y-axis has units of g/100 g product.

FIG. 4 shows the size distribution of total carbohydrates (dark line) and mannans (light line) for Sample D. The x-axis is molecular mass in Da and the y-axis has units of g/100 g product.

FIG. 5 shows the size distribution of total carbohydrates (dark line) and mannans (light line) for Sample E. The x-axis is molecular mass in Da and the y-axis has units of g/100 g product.

FIG. 6 shows the size distribution of total carbohydrates (dark line) and mannans (light line) for Sample CS1. The x-axis is molecular mass in Da and the y-axis has units of g/100 g product.

FIG. 7 shows the size distribution of total carbohydrates (dark line) and mannans (light line) for Sample CS2. The x-axis is molecular mass in Da and the y-axis has units of g/100 g product.

FIG. 8 is a plot of sensory cloudiness score (y-axis) against non-soluble fraction at 4° C. (x-axis).

### DETAILED DESCRIPTION OF THE INVENTION

Consequently the present invention relates in part to a coffee beverage composition comprising coffee extract wherein at least 8 wt. % of the coffee extract solids present (for example at least 8.5 wt. %, for example at least 9 wt. %, for example at least 10 wt. %, for example between 8.5 and 20 wt. %, for further example between 10 and 16 wt. %) are mannans and less than 4.2 wt. % of the coffee extract solids (for example less than 4.0 wt. %, for example less than 3.8 wt. %, for example less than 3.5 wt. %, for example less than 3.0 wt. %, for further example less than 2.5 wt. %) are mannans having a molecular mass greater than 5000 Da. The weight of coffee extract solids present as mannans may be expressed as the weight of mannose after acid hydrolysis.

The coffee beverage composition may be suitable for consumption without further preparation, for example a ready-to-drink coffee. The coffee beverage composition may be a liquid concentrate intended to be mixed with water before consumption. The coffee beverage composition may be a powder intended to be mixed with water before consumption. The coffee beverage composition may be a coffee mix, for example a powder mixture of soluble coffee and sucrose.

The coffee extract according to the invention may be a dried coffee extract, for example a soluble coffee powder such as a pure soluble coffee powder. Soluble coffee is a phrase used to describe coffee which has been prepared by extraction of roast and ground coffee followed typically by drying of the extract into a powdered product by means such as freeze-drying or spray-drying. In order to prepare a coffee beverage, water is then simply added to the powder thus avoiding the complicated and time-consuming process which is involved when preparing a beverage from traditional roast and ground coffee. Although the material referred to as soluble coffee is predominantly comprised of soluble material there is usually a small amount of insoluble material present.

The coffee beverage composition may be a soluble coffee powder, for example a pure soluble coffee. A pure soluble coffee contains only materials derived from coffee. The coffee beverage composition may be a spray dried or a freeze dried coffee powder. In an embodiment the coffee beverage composition has a moisture content between 2 and 5 wt. %.

The soluble coffee powder according to the invention may be a spray-dried or freeze-dried soluble coffee powder. The coffee extract is preferably an aqueous extract of roast coffee, for example an aqueous extract of roast and ground coffee. To form a coffee extract, roasted coffee is extracted with an aqueous liquid such as water itself or an aqueous coffee extract. An extract of unroasted coffee may be comprised in the coffee beverage composition, but preferably the majority of the coffee, for example all the coffee has been roasted. In the current invention, the term coffee extract solids refers to the non-water components of a coffee extract.

Coffee extraction used in the home to brew coffee from roast and ground beans at water temperatures between 80° C. and 100° C. produces a weak extract at low yield. Such an extract can be relatively clear. However, for industrial coffee extraction such as in the manufacture of soluble coffee, a much higher yield is required for economic and technical reasons. There is a marked increase in polysaccharides content in coffee extracts once water-extracting temperatures are raised above 150° C. and generally so up to 180° C. The presence of polysaccharides allows the coffee extract to be dried to a stable powder (for example by spray-drying or freeze drying) without the need to add carriers such as maltodextrin.

In an embodiment, the coffee extract according to the invention comprises at least 18 wt. % total carbohydrates. These high yield coffee extracts are characterized by at least 8 wt. % of the coffee extract solids being galactomannans, polymers of predominantly mannose, referred to in this application as “mannans”. Coffee mannans are poorly water-soluble below 100° C., forming ordered aggregates responsible for extract turbidity. The inventors have found that by reducing the quantity of high molecular weight mannans (for example greater than 5000 Da) in a coffee extract they can reduce turbidity. Furthermore, the dissolution performance of a dried coffee extract can be improved by controlling the size of the mannans present.

Without wishing to be bound by theory, the inventors believe that this improved dissolution is due to a viscosity effect. When soluble coffee powder is placed in water, the water starts to penetrate any open pores and gaps between agglomerated particles. The water begins to dissolve the coffee, but as it does so it produces a locally high concentration of coffee. The viscosity of these locally high concentration regions retards further penetration of the water. Greater quantities of high molecular weight mannans lead to a greater viscosity which slows the dissolution locally, retarding penetration into pores and separation of agglomerates. This manifests itself in unsightly pieces of undissolved instant coffee remaining visible in the cup and the formation of lumps of powder. The problem is especially bad in cold water where solubility is lower and viscosity higher. The inventors have found that by limiting the quantity of high molecular weight mannans (for example greater than 5000 Da) in a coffee extract they can improve dissolution.

Coffee carbohydrates may be quantified by anion exchange chromatography as a composition in monosaccharides after acid hydrolysis. The quantity of mannans may for example be measured by quantifying the total mannose after acid hydrolysis. The molecular weight distribution of the mannan molecules may be established by size exclusion chromatography after the fractionation of coffee polysaccharides e.g. mannans and arabinogalactans. The mannans fraction above 5000 Da may be expressed as total mannose after acid hydrolysis.

Roasting coffee is a heat treatment performed to develop the typical flavour and aroma of roasted coffee as well as darkening the colour of the beans. Roasting is normally carried out with hot combustion gases and excess air as the primary heating agent, although heat may also be produced by contact with hot metal surfaces. The heating of the beans leads to evaporation of water, and as the temperature rises inside the beans, chemical reactions take place, including Maillard reactions. The typical aroma and flavour compounds characterising roasted coffee are formed and the colour of the beans becomes darker. The temperature of the coffee beans typically reaches between about 170° C. and about 260° C. during roasting. The roasting time typically varies between about 1 minute and about 30 minutes. The degree of roasting applied depends on the desired aroma and flavour characteristics of the beans.

Roasting degree can be determined by roast bean colour, ranging from light to extra dark, each of the colour levels being associated with a different flavour profile. Light roasts are light brown in colour, with a light body and no oil on the surface of the beans. Light roast has usually a toasted taste and pronounced acidity. Light roasted beans usually reach product temperatures between 180° C. to 205° C. during roasting. Medium roasted coffee are medium brown in colour with more body than light roasts, with no oil in the surface of the bean. Medium roast exhibits more balanced flavour, aroma and acidity. Medium roasted coffee beans usually reach product temperatures between 210° C. and 220° C. during roasting. Medium to dark roasts have a darker colour with some oil beginning to show on the surface of the beans. Medium to dark roasted beans have a heavy body in comparison with the light or medium roasts. Flavours and aromas of roasting are more pronounced. The medium to dark roasted beans usually reach an internal temperature of about 225° C.-230° C. during roasting. Finally, extra dark roasts are dark brown in colour or sometimes even almost black.

Roast bean colour may be expressed in CTN units. CTN roast colour may vary from about 200 to about 40 and is determined by measuring the intensity of Infrared (IR) light (904 nm) that is back scattered by the sample when measured with a spectrophotometer, such as Neuhaus Neotec's ColorTest II®. The spectrophotometer illuminates the surface of the ground sample with monochromatic IR light at a wavelength of 904 nm from a semi-conductor source. A photo-receiver, which has been calibrated, measures the amount of light reflected by the sample. The mean value series of measurement is calculated and displayed by electronic circuit. The colour of the coffee beans is related to its roast level. For example, green (unroasted) coffee beans would typically have a CTN of about 200 by extrapolation, extremely lightly roasted coffee beans typically have a CTN of around 150, lightly roasted coffee beans have typically a CTN around 100 and medium-dark coffee beans have typically a CTN of around 70. Very dark roasted coffee beans typically have a CTN of around 45.

The inventors have found that light roast coffees are particularly suitable for forming coffee beverages that are prepared cold. In an embodiment, the coffee beverage composition comprises, for example consists of, coffee wherein the coffee has been roasted to a colour of between 80 and 130 CTN, for example between 70 and 100 CTN.

The coffee beverage composition may be free from insoluble roast and ground coffee, for example micronized roast and ground coffee particles. Micronized roast and ground coffee is finely ground roast coffee. Micronized roast and ground coffee is sometimes added to soluble coffee to improve its aroma profile. The presence of roast and ground coffee particles may increase the turbidity of the coffee beverage.

Non-soluble components contribute to turbidity. In the context of the present invention, non-soluble refers to being non-soluble in water. The non-soluble fraction of a soluble coffee made up in water may for example be determined by filtration to quantify particles having a size at which they are visible. The non-soluble fraction is expressed as a weight percentage of the soluble coffee powder on a solids basis. For example, the non-soluble fraction of the soluble coffee powder according to the invention may be the percentage of non-soluble material when 1 wt. % of the soluble coffee powder is made up in water at 4° C. For example the non-soluble fraction of the soluble coffee powder according to the invention may be the percentage of non-soluble material having a diameter greater than 0.8 μm when 1 wt. % of the soluble coffee powder is made up in water at 4° C. For example the non-soluble fraction of the soluble coffee powder according to the invention may be the percentage of non-soluble material retained on a 0.8 μm porosity filter when 1 wt. % of the soluble coffee powder is made up in water at 4° C. and passed through the filter. For further example, the non-solid fraction of a soluble coffee powder may be determined by preparing 10 g of a soluble coffee powder at 1 wt. % in water at 4° C. and then filtering on paired 0.8 μm porosity filters whilst applying vacuum. In an embodiment, the coffee beverage composition is a soluble coffee powder having a non-soluble fraction of less than 3 wt. % at 4° C., for example less than 2.5 wt. %, for example less than 2 wt. %. A non-soluble fraction of 3 wt. % at 4° C. approximately corresponds to a sensory cloudiness score of 3. For a clear beverage it is considered desirable to have a sensory cloudiness score below 3. In an embodiment the coffee beverage composition of the invention provides a beverage having a sensory cloudiness score below 3 wherein the sensory cloudiness of the coffee is assessed by adding 200 ml of water at 4° C. to 2.6 g of soluble coffee in a 400 mL glass having diameter 12 cm and stirring to dissolve, whereupon a standard metal spoon is dipped into the coffee and filled to the point where a 5 mm gap is left at the edge of the spoon and the cloudiness of the beverage is then assessed by a panel according to the scale from 0 (not cloudy) to 10 (very cloudy).

The coffee beverage composition of the invention dissolves quickly when prepared by consumers even in cold water. In an embodiment the coffee beverage composition is a soluble coffee powder having a reconstitution time t90 at 4° C. of less than 40 s, for example less than 35 s, for further example less than 30 s. The reconstitution time t90 is the time taken for 90% of the soluble coffee powder to dissolve. For example, the reconstitution time may be measured by conductivity. The reconstitution time may be measured by discharging 10 g of soluble coffee powder onto 400 ml of water (for example demineralized water) stirred with a stirring bar and an overhead stirrer, the water being at 4° C., and measuring the increase in conductivity of the solution as a function of time, the t90 time being the time taken to reach 90% of the final conductivity.

In the context of the present invention, the term “closed pores” is used to define completely closed voids present in soluble coffee powder particles. In contrast, “open pores” are voids having a connection to the surface of the particle. Liquids such as water cannot penetrate into the closed pores before the particle dissolves. This results in the formation of air bubbles in the coffee as the soluble coffee powder dissolves. These bubbles increase the opacity of the resulting coffee. In an embodiment the coffee beverage composition is a soluble coffee powder having a closed porosity of less than 20%, for example less than 18%.

The closed porosity is calculated from the skeletal density and the matrix density.

$$Closed porosity ( \% ) = 100 \times ( 1 - \frac{skeletal density}{matrix density} )$$

The skeletal (apparent) density of a coffee powder may be determined by measuring the volume of a weighed amount of powder using a nitrogen pycnometer and dividing the weight by the volume. The skeletal density is a measure of density that includes the volume of any voids present in the powder that are sealed to the atmosphere and excludes the volume of any voids open to the atmosphere.

The coffee matrix density is sometimes referred to as the “true density” of the solid material forming the coffee powder. The coffee matrix density may be measured by grinding the coffee powder to open all internal voids. The density obtained by nitrogen pycnometry for the ground powder is the coffee matrix density. However, this method is hard to perform accurately with a sample having very small pores as it is difficult to ensure all pores are opened during grinding, so it is preferred to measure the density of liquid coffee at different concentrations and extrapolate to the coffee matrix density value at 0% moisture content. In an embodiment, the closed porosity is calculated from the skeletal density measured by nitrogen pycnometry and the matrix density measured by extrapolation of the density of liquid coffee at different concentrations.

The use of added enzymes to hydrolyse coffee carbohydrates and alter the carbohydrate size profile is not always desirable as consumers may expect their coffee beverage to contain nothing which doesn't originate from coffee. In addition, many regulatory authorities prohibit the use of enzymes in the production of material labelled “pure soluble coffee”. Thermally driven hydrolysis is therefore preferrable. In an embodiment the coffee beverage composition is free from enzymes.

The use of enzymes to hydrolyse mannans can result in a distinctive pattern of polymers. In particular, hydrolysis catalysed by mannanase may result in the formation of the more mannose oligomers with a degree of polymerization of three (mannotriose) than degree of polymerization two (mannobiose). In an embodiment, the coffee beverage composition comprises mannotriose in an amount less than 1.5 (for example less than 1.3, for example less than 1.2) times the amount of mannobiose by weight. For example the coffee beverage composition may comprise coffee extract having mannotriose in an amount less than 1.5 (for example less than 1.3, for example less than 1.2) times the amount of mannobiose by weight.

The use of added acids to hydrolyse coffee carbohydrates and alter the carbohydrate size profile is not always desirable as consumers expect their coffee beverage to contain nothing which doesn't originate from coffee. In addition, many regulatory authorities prohibit the use of acids in the production of material labelled “pure soluble coffee”. Thermally driven hydrolysis is therefore preferrable. In an embodiment the coffee beverage composition is free from added acid, for example free from sulphuric acid or phosphoric acid. In an embodiment the coffee beverage composition comprises mannotriose in an amount less than 1.5 (for example less than 1.3, for example less than 1.2) times the amount of mannobiose by weight and is free from sulphuric acid or phosphoric acid.

Beverage preparation devices (for example beverage preparation machines) which accommodate extractable portioned ingredients provide a convenient method of preparing beverages. Such portioned ingredients are generally packed in a container, configured for example as a pod, pad, sachet, pouch, capsule or the like. An aspect of the invention provides a container for use in a beverage preparation device, the container containing the coffee beverage composition of the invention. The container being for the preparation of a beverage when inserted into a beverage preparation device. The container may for example be a beverage capsule, among other configurations.

An aspect of the invention provides a method of manufacturing a coffee beverage composition, the method comprising;
a. extracting soluble coffee solids from ground roasted coffee in a first extraction stage using an aqueous extraction fluid at a temperature of 80° C. to 150° C. (for example 90° C. to 130° C., for example 100° C. to 120° C.) for 1 to 60 minutes (for example 10 to 55 minutes, for example 20 to 50 minutes) to provide a primary coffee extract and primary extracted coffee grounds,
b. extracting soluble coffee solids from the primary extracted grounds in a second extraction stage using an aqueous extraction fluid at a temperature of 151° C. to 190° C. (for example 160° C. to 180° C.) for 1 to 80 minutes (for example 10 to 75 minutes for example 20 to 70 minutes, for example 30 to 60 minutes) to provide a secondary coffee extract and secondary extracted coffee grounds,
c. optionally subjecting the secondary extracted coffee grounds to a heat treatment in the presence of water from 191° C. to 260° C. (for example 195° C. to 205° C.) for 1 to 15 minutes (for example 4 to 8 minutes) and either separating the liquid portion as tertiary coffee extract or performing an aqueous extraction of the heat treated secondary extracted coffee grounds to provide a tertiary coffee extract.
d. treating at least part of the secondary coffee extract at a temperature of 170° C. to 220° C. (for example 180° C. to 210° C.) for 1 to 60 minutes (for example 10 to 55 minutes, for example 20 to 50 minutes) to provide hydrolysed secondary coffee extract,
e. optionally treating at least part of the tertiary coffee extracts at a temperature of 170° C. to 220° C. (for example 180° C. to 210° C.) for 1 to 60 minutes (for example 10 to 55 minutes, for example 20 to 50 minutes) to provide hydrolysed tertiary coffee extract,
f. forming a combined coffee extract comprising (for example consisting of) on a solids basis 20-60 wt. % primary coffee extract, 0-25 wt. % secondary coffee extract, 20-70 wt. % hydrolysed secondary coffee extract, 0-30 wt. % tertiary extract and 0-30 wt. % hydrolysed tertiary coffee extract.

The aqueous extraction fluid may be a coffee extract, for example the aqueous extraction fluid in the first extraction stage may be secondary coffee extract. The aqueous extraction fluid may be water. In an embodiment the aqueous extraction fluid in step a is secondary coffee extract and in step b is water. In an embodiment the aqueous extraction fluid in step a and/or b is water. In an embodiment, the method of the invention is not a counter-current process.

In an embodiment the secondary extracted coffee grounds are subjected to a heat treatment in step c by forming a slurry comprising water and the secondary extracted coffee grounds at between 5 to 20% by weight of the slurry. For example the secondary 10 extracted coffee grounds may be subjected to a heat treatment in step c by forming a slurry comprising water and the secondary extracted coffee grounds at between 5 to 20% by weight of the slurry, subjecting the slurry to a temperature of from 200° C. to 260° C. for 1 to 15 minutes and separating the liquid portion as tertiary coffee extract.

In an embodiment, the treatment of at least part of the secondary coffee extract in step d is performed in the absence of coffee grounds. By hydrolysing the secondary coffee extract in the absence of grounds, the molecular weight of the already extracted mannans can be tailored without interference from still unextracted mannans. If grounds were present, mannans would continue to be extracted at an uncontrolled molecular weight.

In an embodiment, the treatment of at least part of the tertiary coffee extracts in step e is performed in the absence of coffee grounds. By hydrolysing the tertiary coffee extract in the absence of grounds, the molecular weight of the already extracted mannans can be tailored without interference from still unextracted mannans. If grounds were present, mannans would continue to be extracted at an uncontrolled molecular weight.

In an embodiment, the combined coffee extract of step f on a solids basis comprises (for example consists of) 30-50 wt. % primary coffee extract, 5-20 wt. % secondary coffee extract, 25-55 wt. % hydrolysed secondary coffee extract, 0-30 wt. % tertiary extract and 0-30 wt. % hydrolysed tertiary coffee extract. In a further embodiment, the combined coffee extract of step f on a solids basis comprises (for example consists of) 30-50 wt. % primary coffee extract, 5-20 wt. % secondary coffee extract, 25-50 wt. % hydrolysed secondary coffee extract, 0-30 wt. % tertiary extract and 0-30 wt. % hydrolysed tertiary coffee extract, wherein the combined coffee extract comprises a total amount of tertiary extract and hydrolysed tertiary extract of 0-30%, for example 5-25%. In a further embodiment, the combined coffee extract of step f on a solids basis comprises (for example consists of) 30-50 wt. % primary coffee extract, 5-20 wt. % secondary coffee extract, 25-50 wt. % hydrolysed secondary coffee extract, 0-25 wt. % tertiary extract and 5-30 wt. % hydrolysed tertiary coffee extract. In a further embodiment, the combined coffee extract of step f on a solids basis comprises (for example consists of) 30-50 wt. % primary coffee extract, 5-20 wt. % secondary coffee extract, 25-50 wt. % hydrolysed secondary coffee extract, 5-30 wt. % tertiary extract and 0-25 wt. % hydrolysed tertiary coffee extract.

The combined coffee extract may be concentrated. For example the combined coffee extract may be concentrated to form a liquid coffee extract suitable to be reconstituted with water.

In an embodiment, the combined coffee extract is dried to form a soluble coffee powder. The combined coffee extract may be pre-concentrated by methods known in the art before being dried. The combined extract may be spray dried. The combined coffee extract may be freeze dried. The combined coffee extract may be vacuum dried.

The coffee may be arabica coffee (Coffea arabica), robusta coffee (Coffea canephora) or a blend of arabica and robusta coffee. The coffee may be ground to a particle size D(4,3) between 50 and 5000 μm, for example between 200 and 2500 μm. The particle size may for example be measured by laser light scattering.

The ground roasted coffee may be coffee that has been roasted to a CTN colour of between 80 and 130, for example between 70 and 100.

Volatile aroma compounds may be recovered from the coffee grounds and/or one or more of the extracts (e.g. by steam stripping and/or the use of vacuum) and added to the combined coffee extract. This avoids loss of aroma. The recovered volatile compounds may be added back to the combined coffee extract. Methods for aroma recovery and add-back are well known in the art of soluble coffee production.

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1: Preparation of Coffee Beverages

Arabica beans are roasted to a color of CTN 75 are ground and fed into the extraction system made up of three fixed bed extractors. The fixed bed reactors are connected in series. The extraction system is started up such that roasted and ground coffee is loaded successively in the first reactor (reactor 1), the second (reactor 2) and the last reactor (reactor 3), while extraction fluid is fed into reactor 1 and coffee extract is collected successively at the least extracted reactor (reactor 1, then 2, then 3). Once the three reactors are connected in series, the primary extraction stage is established and the primary coffee extract leaving reactor 3 is collected. Hot water at a temperature of between 100° C. and 120° C. is used as the extraction fluid during the primary extraction. The total solids content of the primary coffee extract is about 4% w/w. The grounds remaining in the reactor at this stage are the primary extracted coffee grounds.

Once the primary coffee extract is collected, the temperature of the extraction fluid feeding the train of fixed bed reactors is increased to create conditions of the secondary extraction. The primary extracted coffee grounds remain in the reactors, no fresh roasted and ground coffee is introduced. While the system temperature is stabilizing, transition extract is collected and discarded. After extraction conditions are established, the secondary coffee extract leaving reactor 3 is collected. Hot water at a temperature of between 160° C. and 180° C. is used as the extraction fluid during the secondary extraction. The total solids content of the secondary coffee extract is about 3.5% w/w. The grounds remaining in the reactor are the secondary extracted coffee grounds.

Spent coffee grounds from the most extracted reactor from the secondary extraction (reactor 1) are collected as secondary extracted coffee grounds. These are suspended in water to form a slurry of 15% w/w dry matter concentration and introduced in a pressurized reactor. The reactor is pressurized to prevent water evaporation and the temperature is increased to between 195° C. to 230° C. for between 4 and 8 min. After cooling and depressurization to atmospheric pressure, the free extract is separated from the slurry by filtration and further extraction fluid is added to wash the filter cake. The combination of the free extract collected from slurry separation and the product of filter cake washing constitutes the tertiary coffee extract. The total solids content of the tertiary coffee extract is about 1.7% w/w.

For some samples, part of the secondary extract is heated at between 170° C. and 190° C. for 10 to 60 minutes to provide hydrolysed secondary coffee extract.

For some samples, part of the tertiary extract is heated at between 170° C. and 190° C. for 25 to 35 minutes to provide hydrolysed tertiary coffee extract.

The primary coffee extract, secondary coffee extract, hydrolysed secondary coffee extract and hydrolysed tertiary coffee extract are combined in different proportions as listed on the table below.

| Weight % on dry solids basis | A | B | C | D | E |
|---|---|---|---|---|---|
| Primary coffee extract | 35 | 36 | 32 | 32 | 50 |
| Secondary coffee Extract | 15 | 1 | 28 | 23 | 50 |
| Hydrolysed secondary coffee extract | 30 | 42 | 40 | 17 | — |
| Hydrolysed tertiary coffee extract | 20 | 22 | — | 28 | — |

### Example 2: Carbohydrate Analysis

The mannose present in the samples was assessed after acid hydrolysis using high performance anion exchange chromatography coupled with pulsed amperometric detection (HPAEC-PAD), according to ISO 11292-1995. 30 mg of the soluble coffee powders was mixed to 200 μL of H₂SO₄ 72% and pre-hydrolysed for 30 min at ambient temperature. The pre-hydrolysed coffee was then made up to 2.5 ml with distilled water and hydrolysed for 2 hours at 100° C. The neutralized sample was cleaned on C18 cartridge and characterized by chromatography. Quantification of mannose was performed by reference to an external standard. The mannan quantity is expressed as the weight of mannose after hydrolysis.

The molecular weight distribution of total carbohydrates and mannans present in the sample was established by size exclusion chromatography. A 2.5% sample solution was prepared in KOH 1N. A 100 μL aliquot was immediately injected and separated on two gel permeation columns in series (i.e. Superose 6 Increase 10/300 GL+Superdex 30 Increase 10/300 (GE Healthcare)) eluted in KOH 0.1N at 0.5 ml/min using a AXP-MS pump (Dionex). A specific post-column detection of carbohydrate was conducted using an autoanalyzer 3 (Bran Luebbe) and the orcinol/sulfuric acid method from Dubois. The molecular weight calibration was performed using a series of oligomannan standards (M1, M3, M6) and monodisperse pullulans between 5′000-800′000 Da (P5, P50, P200, P800) (Sigma-Aldrich).

The samples were sequentially fractionated to recover the arabinogalactan fraction after sample clean-up for oligosaccharides and mannans.

A 50% solution of sample was prepared in hot water and then cooled down. The solution was precipitated overnight at 4° C. in 80% ethanol (V/V) to recover the high molecular weight (HMW). The suspension was then filtered (0.45 μm) and the HMW residue washed thoroughly with pure ethanol till dry. Yield of the HMW fraction was determined gravimetrically.

A 10% solution of HMW fraction was further prepared in hot water to which mannanase (BGM “Amano” 10) was added at 1% enzyme/HMW ratio (W/W). The hydrolysis was conducted at 50° C. overnight under gentle stirring. The cooled hydrolysate was precipitated overnight at 4° C. in 80% ethanol (V/V) and the HMW Arabinogalactan (AG) residue was recovered as previously described. Yield of the HMW AG fraction was determined gravimetrically.

The carbohydrate content and size exclusion chromatography profile were established on the native sample, the HMW and HMW AG fractions. The characteristics of the HWM mannan fraction was determined by difference between the HMW and the HMW AG fractions.

### Example 3: Non-Soluble Fraction Determination and Cloudiness

Samples A, B, C, D and E were prepared at larger scale but with the same carbohydrate profiles as in Example 1 and spray dried to form powders.

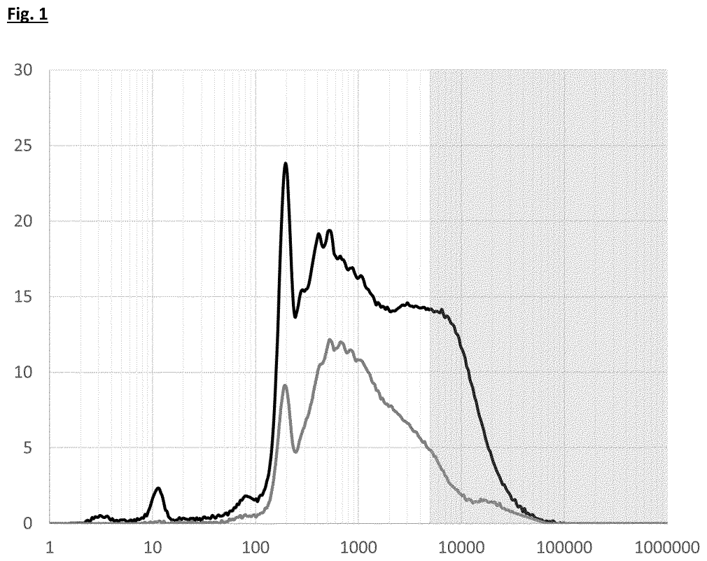

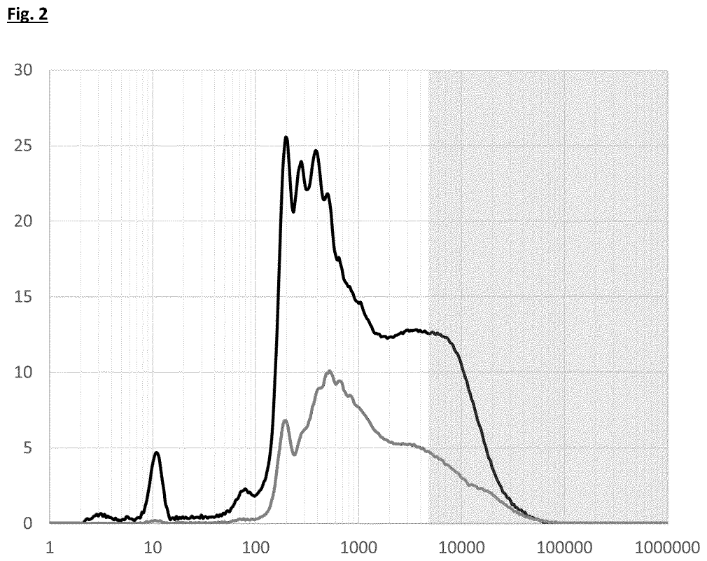

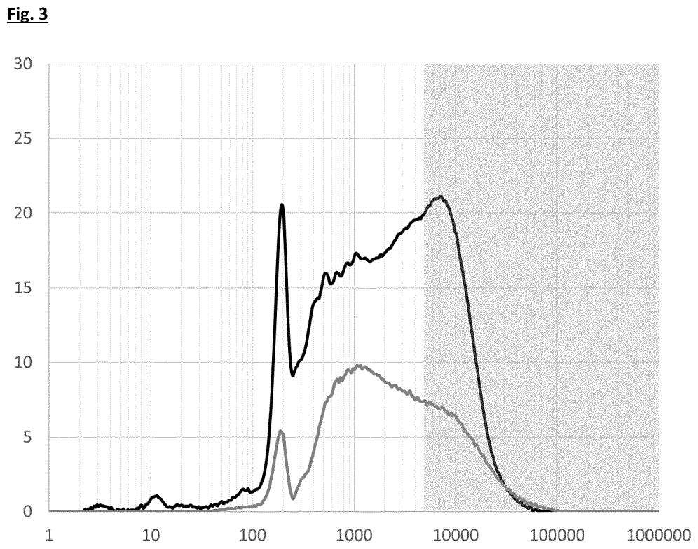

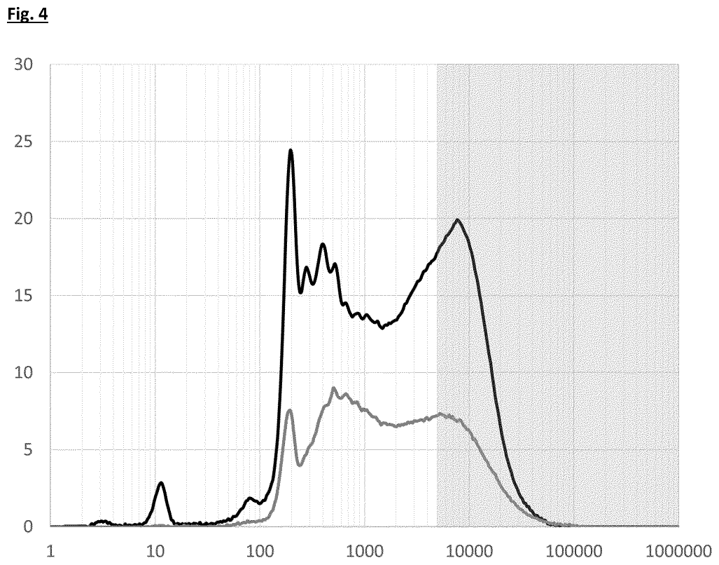

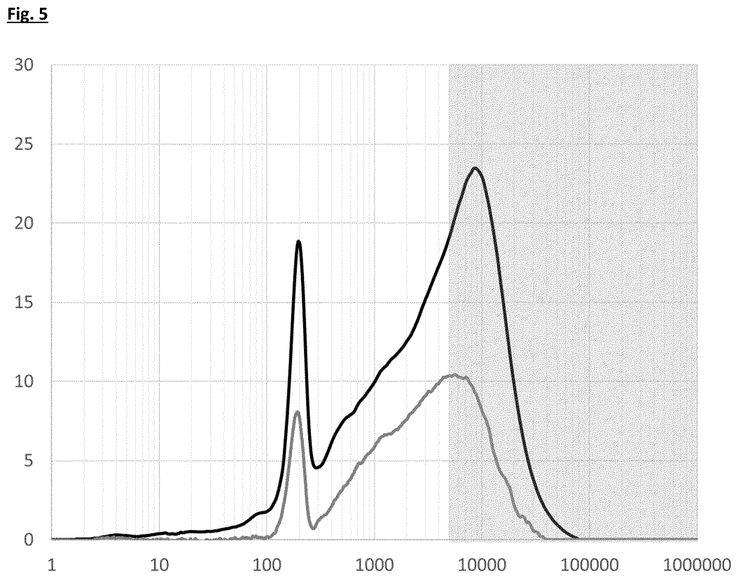

The size distributions of the carbohydrates of extracts A, B, C, D and E are plotted in FIGS. 1-5.

The mannan quantity expressed as the weight of mannose after hydrolysis and the weight of mannans having a molecular mass greater than 5000 Da are listed in the table below. Both values being given as a percentage of the weight of initial sample.

| Sample | Mannan (wt. %) | Mannan > 5000 Da (wt. %) |
|---|---|---|
| A | 15.6 | 2.0 |
| B | 16.5 | 2.5 |
| C (comparative) | 16.4 | 4.7 |
| D (comparative) | 16.4 | 4.3 |
| E (comparative) | 10.3 | 5.0 |

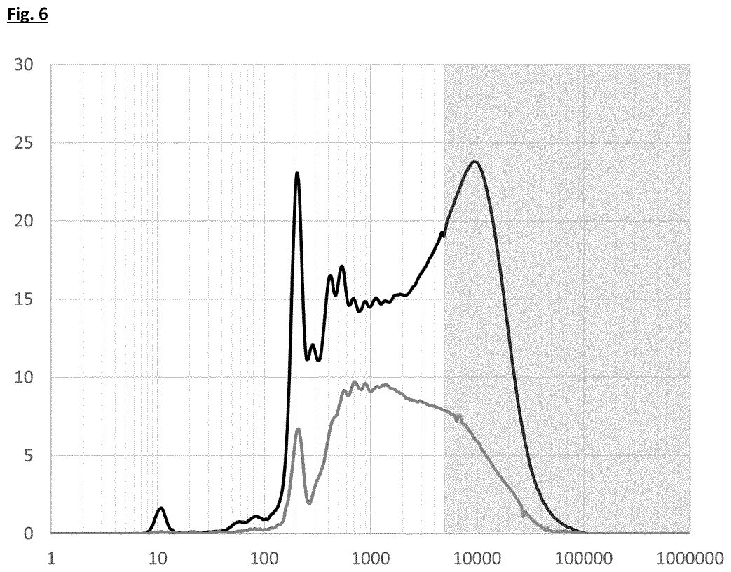

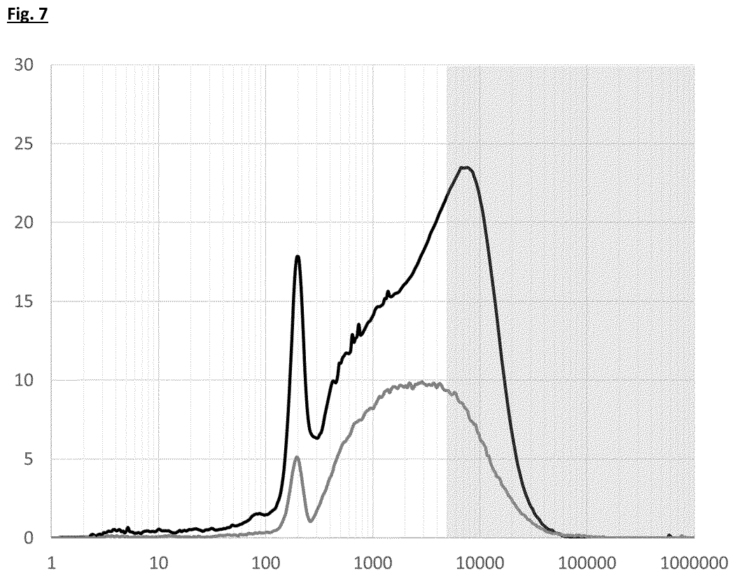

The carbohydrate profiles of the commercial samples CS1 and CS2 were measured in the same way. These are plotted in FIG. 6 and FIG. 7.

| Sample | Mannan (wt. %) | Mannan > 5000 Da (wt. %) |
|---|---|---|
| CS1 | 17.0 | 4.3 |
| CS2 | 14.3 | 4.6 |

The non-soluble fractions of the sample coffees are measured as follows: 10 g of each coffee powder is prepared at 1 wt. % in a 100 ml volumetric flask using Aqua Panna water at 4° C. The solution is immediately turned upside down and shaken prior to filtration. A portion (5 to 15 g) of the solution is filtered through MF-Millipore paired filters (porosity 0.8 μm, diameter 47 mm) using vacuum. After filtration, the two filters are carefully separated and dried in an oven at 80° C. for 30 minutes. The weight of the filters is determined at 0.00001 g accuracy. The non-soluble fraction is determined as the weight difference between the upper (non-soluble fraction) filter and lower (blank) filter. The non-soluble fraction is expressed as wt. % of the coffee powder.

The sensory cloudiness of the coffee is assessed as follows: 200 ml of Aqua Panna water at 4° C. is added to 2.6 g of soluble coffee in a 400 mL glass having diameter 12 cm and stirred to dissolve. A standard metal spoon is dipped into the coffee and filled to the point where a 5 mm gap was left at the edge of the spoon. The cloudiness of the beverage is then assessed by a panel according to the scale from 0 (not cloudy) to 10 (very cloudy). An example scale with photographs was provided to the panel members to aid consistency.

| | Non soluble fraction | |
|---|---|---|
| Sample | at 4° C. (wt. %) | Sensory cloudiness |
| A | 2.5 | 2.5 |
| B | 1.0 | 1.1 |
| C (comparative) | 3.7 | 5.8 |
| D (comparative) | 3.7 | 3.8 |
| E (comparative) | 3.5 | Not measured |
| CS1 | 6.0 | 6.6 |
| CS2 | 4.8 | 4.8 |

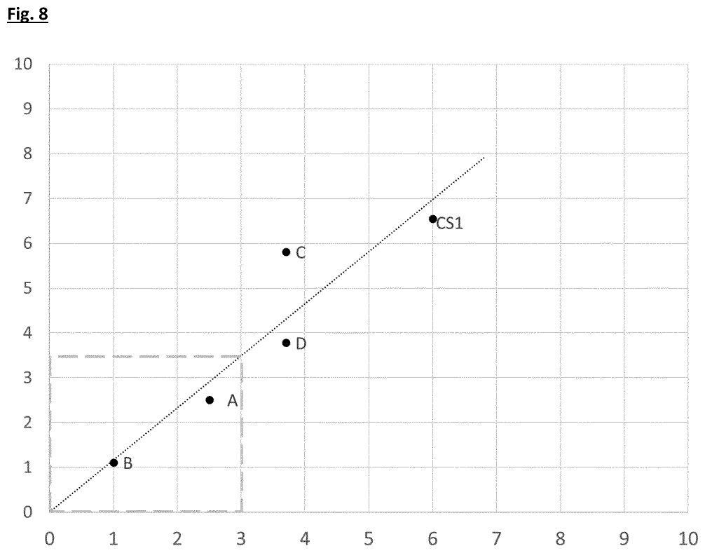

The non-soluble fraction value increases with the sensory cloudiness score, FIG. 8.

Samples A and B (according to the invention) have lower levels of mannan with molecular mass greater than 5000 Da than the other samples and have a lower non soluble fraction at 4° C. and a lower sensory cloudiness score. It can be seen that a coffee beverage composition with low turbidity may be obtained from a high yield coffee extract by ensuring that mannans having a molecular mass greater than 5000 Da are limited, for example less than 4.2 wt. % of the coffee extract solids are mannans having a molecular mass greater than 5000 Da.

### Example 4: Solubility

Powders are characterized in terms of reconstitution kinetics by means of a conductivity module (Module 856, Metrohm SA). The module is connected to a conductivity probe with an acquisition frequency of 10 Hz (Pt1000/B/2 0-70° C., Metrohm SA). The device is assembled with a 400 mL double-jacketed vessel connected to an external water bath to regulate the temperature. The vessel is a straight-sided cylinder of internal diameter 80 mm. The powders are agitated with the aid of a magnetic stirring bar (cylindrical 50×8 mm²) rotating at 250 rpm at the bottom of the vessel. A stirring propeller (internal diameter 25.6 mm with 6 blades) rotating at 60 rpm is used to agitate the powders at the top of the solution. The experiment consists of discharging 10 g of powder onto 400 ml of demineralized water (leading to a final concentration of 2.5 weight %) at 4° C. The objective of the method is to characterize how fast the powder crosses the water-air interface and dissolves with the aid of two rotating agitators at the top and bottom of the vessel. The conductivity probe measures the increase in conductivity of the solution as a function of time and thereby quantifies the amount of powder solubilized. The results are reported as the reconstitution time or t90 (seconds), corresponding to the relative time required to reach 90% of the final conductivity signal measured by the probe.

| Sample | Reconstitution time t90 (sec) |
|---|---|
| A | 22.0 |
| B | 26.2 |
| E (comparative) | 50.3 |
| CS1 | 48.0 |

### Example 5: Method of Measuring Pore Structure with Nitrogen Porosimetry

The skeletal density dₛ of the coffee particles of Sample A was measured with a gas displacement pycnometry System (AccuPyc 1340, Micromeritics). The measurement cell of the pycnometer was filled at two-thirds of its volume and the sample weight recorded. The following parameters were used: 10 purges, purge and measurement pressure of 134 kPag; average of 3 runs. The volume of gas that penetrates into the measurement chambers allows the computation of the skeletal density in g/cm³ by the equipment. Skeletal density is a measure of the material density that includes closed voids in the particles but excludes all the voids that are open to the atmosphere (open porosity and interstitial voids between particles). The skeletal density was measured with a gas displacement pycnometer and nitrogen gas. Nitrogen has a lower tendency to diffuse into the matrix material than gasses such as helium, making it easier to achieve stringent equilibration criteria. The equilibration criteria for nitrogen was set at 0.0345 kPa/min (called “equilibration rate” in the instrument software).

Closed porosity of the sample is then deduced by dividing the skeletal density dₛ by the coffee matrix density dₘ

$$Closed porosity ( \% ) = 100 \times ( 1 - \frac{{d}_{s}}{{d}_{m}} )$$

The coffee matrix density was measured by grinding the sample for 8 minutes in a SPEX Sample Prep 6875 freezer mill and then performing nitrogen pynometry as above.

With a coffee matrix density of 1.54 g/cm³ the closed porosity of Sample A was calculated as 15.5%.

1. A coffee beverage composition comprising coffee extract wherein at least 8 wt. % of the coffee extract solids present are mannans and less than 4.2 wt. % of the coffee extract solids are mannans having a molecular mass greater than 5000 Da.

2. The coffee beverage composition according to claim 1 wherein the coffee beverage composition is a soluble coffee powder.

3. The coffee beverage composition of claim 2 having a non-soluble fraction of less than 3 wt. % at 4° C.

4. The coffee beverage composition of claim 2 having a reconstitution time t90 at 4° C. of less than 40 s.

5. The coffee beverage composition of claim 1 having a closed porosity of less than 20%.

6. The coffee beverage composition according to claim 1, wherein the beverage is free of enzymes.

7. The coffee beverage composition according to claim 1, wherein the coffee beverage composition comprises mannotriose in an amount less than 1.5 times the amount of mannobiose by weight.

8. A container for use in a beverage preparation device, the container containing the coffee beverage composition comprising coffee extract wherein at least 8 wt. % of the coffee extract solids present are mannans and less than 4.2 wt. % of the coffee extract solids are mannans having a molecular mass greater than 5000 Da.

9. A method of manufacturing a coffee beverage composition, the method comprising;
a. extracting soluble coffee solids from ground roasted coffee in a first extraction stage using aqueous extraction fluid at a temperature of 80° C. to 150° C. for 1 to 60 minutes to provide a primary coffee extract and primary extracted coffee grounds,
b. extracting soluble coffee solids from the primary extracted grounds in a second extraction stage using aqueous extraction fluid at a temperature of 151° C. to 190° C. for 1 to 80 minutes to provide a secondary coffee extract and secondary extracted coffee grounds,
c. treating at least part of the secondary coffee extract at a temperature of 170° C. to 220° C. for 1 to 60 minutes to provide hydrolysed secondary coffee extract, and
d. forming a combined coffee extract comprising on a solids basis 20-60 wt. % primary coffee extract, 0-25 wt. % secondary coffee extract, 20-70 wt. % hydrolysed secondary coffee extract, 0-30 wt. % tertiary extract and 0-30 wt. % hydrolysed tertiary coffee extract.

10. The method of claim 9 wherein the aqueous extraction fluid in step a and/or b is water.

11. The method of claim 9 wherein the secondary extracted coffee grounds are subjected to a heat treatment in step c by forming a slurry comprising water and the secondary extracted coffee grounds at between 5 to 20% by weight of the slurry.

12. The method of claim 9 wherein the combined coffee extract is dried to form a soluble coffee powder.

13. The method of claim 9 wherein volatile aroma compounds are recovered from the coffee grounds and/or one or more of the extracts and added to the combined coffee extract.
